(19) United States
(12) Patent Application Publication
(10) Pub. No.: US 2014/0009595 A1
(43) Pub. Date: Jan. 9, 2014

(54) IMAGE ACQUISITION APPARATUS AND IMAGE ACQUISITION METHOD

(71) Applicant: CANON KABUSHIKI KAISHA, Tokyo (JP)

(72) Inventor: Shinzo Uchiyama, Utsunomiya-shi (JP)

(21) Appl. No.: 13/926,466

(22) Filed: Jun. 25, 2013

(30) Foreign Application Priority Data
Jul. 4, 2012 (JP) 2012-150470

(51) Int. Cl. H04N 7/18

(52) U.S. Cl. CPC H04N 7/18
USPC 348/79

(57) ABSTRACT

An image acquisition apparatus includes a slide stage to hold a prepared slide, an imaging optical system configured to form an image of the prepared slide, an imaging unit configured to perform imaging of the prepared slide, a stage measurement unit configured to obtain orientation information of the slide stage, and a calculation unit configured to calculate an order of imaging the prepared slide. An orientation of the slide stage is changeable based on the orientation information, and the calculation unit obtains, based on a surface shape of the prepared slide and optical characteristics of the imaging optical system, a relation between an orientation of the slide stage and an area of the prepared slide which can be imaged with respect to the orientation, and calculates an order of imaging the prepared slide in each orientation of the slide stage based on the obtained relation.

### BACKGROUND OF THE INVENTION

1. Field of the Invention

The present invention relates to an image acquisition apparatus including a slide stage which holds a prepared slide. An example of the image acquisition apparatus includes a microscope or the like.

2. Description of the Related Art

An image acquisition apparatus capable of obtaining a digital image by imaging a prepared slide (preparation) that includes a specimen has been getting attention in the field of pathology and so on.

Japanese Patent Application Laid-Open No. 2009-3016 discusses a microscope which uses an objective lens of a wide field of view and provides high resolution imaging. In the microscope discussed in Japanese Patent Application Laid-Open No. 2009-3016, an image sensor group is arranged within the field of view, so that a plurality of images can be captured at one time. The microscope discussed above moves either a slide stage holding a prepared slide or the image sensor group in a horizontal direction, and performs imaging a plurality of times. The microscope then connects (stitches) the obtained partial images, and thus obtains an entire image of a large specimen which does not fit within the field of view of the objective lens.

In the above-described case, if a control error occurs at the time of changing a position or orientation of the slide stage or the image sensor group, the adjacent partial images become misaligned, and the images become deteriorated in respective boundary portions. Accordingly, it becomes difficult to connect the plurality of partial images. The obtained image is severely affected by the misalignment of the partial images even if the misalignment is as small as only one pixel. In particular, if the objective lens is an expanding system, optical magnification thereof is high, so that a tolerance of the misalignment on the object side becomes small. It is thus necessary to accurately measure and control the position and the orientation of the slide stage to reduce the deterioration in image quality due to the misalignment of partial images.

However, if the position and the orientation of the slide stage are to be accurately measured and controlled, it is necessary to perform loop iteration in which heights of three points on the slide stage are measured using a laser displacement meter, and control of the heights of three points is performed based on the measurement information. More specifically, it is necessary to perform such control every time each partial image is captured to obtain the entire image of an observation area of the prepared slide, so that control time becomes long. In particular, if the high-magnification objective lens is to be used, an error tolerance value for controlling the position and the orientation of the slide stage becomes small. Longer time thus may be necessary for obtaining the image.

### SUMMARY OF THE INVENTION

The present invention is directed to reduction in time necessary for obtaining an image in an image acquisition apparatus including a slide stage which holds the prepared slide by reducing an amount and a number of times of changing an orientation of the slide stage.

According to an aspect of the present invention, an image acquisition apparatus includes a slide stage configured to hold a prepared slide, an imaging optical system configured to form an image of the prepared slide, an imaging unit including an image sensor configured to perform imaging of the prepared slide, a stage measurement unit configured to obtain orientation information of the slide stage, and a calculation unit configured to calculate an order of imaging the prepared slide, wherein an orientation of the slide stage is changeable based on the orientation information, and wherein the calculation unit obtains, based on a surface shape of the prepared slide and optical characteristics of the imaging optical system, a relation between an orientation of the slide stage and an area of the prepared slide which can be imaged with respect to the orientation, and calculates an order of imaging the prepared slide in each orientation of the slide stage based on the obtained relation.

Further features of the present invention will become apparent from the following description of exemplary embodiments with reference to the attached drawings.

### BRIEF DESCRIPTION OF THE DRAWINGS

FIG. 1 is a schematic diagram illustrating an image acquisition apparatus according to an exemplary embodiment of the present invention.

FIG. 2 is a schematic diagram illustrating a prepared slide according to the exemplary embodiment of the present invention.

FIG. 3 is a schematic diagram illustrating an imaging unit according to the exemplary embodiment of the present invention.

FIG. 4 is a schematic diagram illustrating a surface shape acquisition unit according to the exemplary embodiment of the present invention.

FIG. 5 is a flowchart illustrating an image acquisition method according to the exemplary embodiment of the present invention.

FIG. 6 is a schematic diagram illustrating prepared slide segments in a prepared slide according to the exemplary embodiment of the present invention.

FIGS. 7A and 7B illustrate how to classify prepared slide segments into segments to be imaged according to the exemplary embodiment of the present invention.

FIG. 8 illustrates an imaging order of prepared slide segments according to the exemplary embodiment of the present invention.

### DESCRIPTION OF THE EMBODIMENTS

Various exemplary embodiments, features, and aspects of the invention will be described in detail below with reference to the drawings. In each of the drawings, the same elements will be assigned the same reference numerals, and redundant description will be omitted.

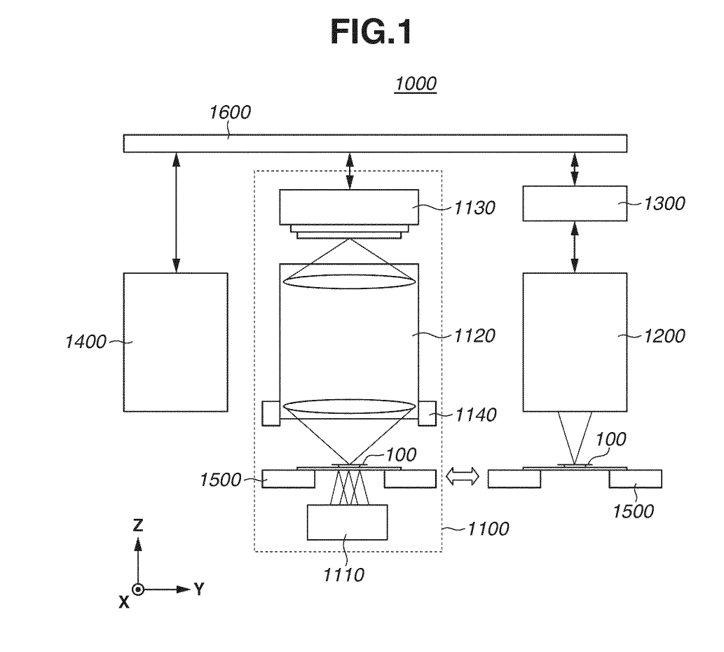

FIG. 1 is a schematic diagram illustrating a main portion of an image acquisition apparatus 1000 according to the present exemplary embodiment. Referring to FIG. 1, the image acquisition apparatus 1000 includes a microscope unit 1100, a surface shape acquisition unit 1200, a calculation unit 1300, an image processing unit 1400, a slide stage 1500, and a control unit 1600.

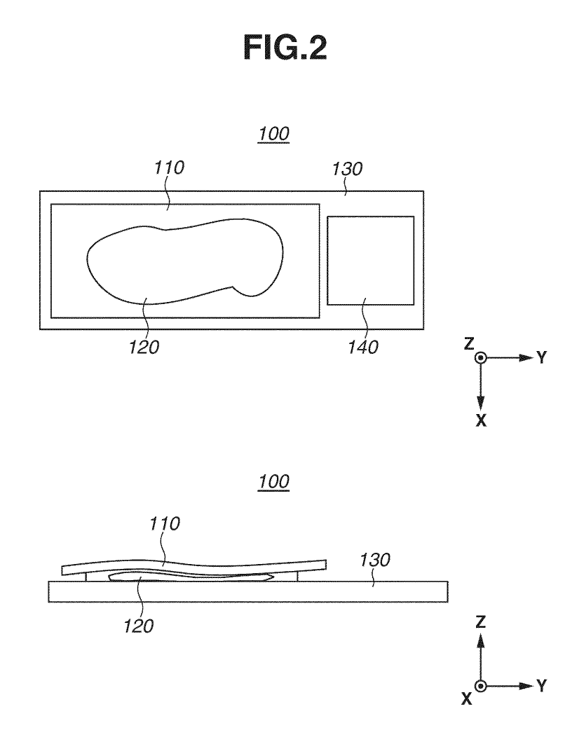

FIG. 2 illustrates an example of a prepared slide 100 which is a target for the image acquisition apparatus 1000 to obtain an image thereof. Referring to FIG. 2, a stained specimen 120 is sandwiched (prepared) in between a cover glass 110 and a slide glass 130 in the prepared slide 100 sealed by a predetermined sealing agent. That is, a slide undergoes preparation with a desired specimen and an appropriate sealing agent. Hence a “prepared slide” 100 is placed in the slide stage 1500 for imaging. The specimen 120 is, for example, a tissue section or a biological sample used in pathological diagnosis. In addition, the specimen 120 may be a substrate subjected to an appearance inspection (e.g., checking whether a foreign particle is attached, or whether there is a scratch) used in semiconductor fabrication. A label 140 such as a two-dimensional code, a one-dimensional bar code, or an integrated circuit (IC) chip may be attached to the slide glass 130. Information for managing the prepared slide 100, such as an identification number, can be recorded in the label 140. Further, the information about a surface shape, segments to be imaged, and the imaging order (to be described in detail below) of the prepared slide 100 may be written in the label 140, so that the microscope unit 1100 performs an image acquisition operation based on the information recorded in the label 140.

The microscope unit 1100 will be described in detail below with reference to FIG. 1.

The microscope unit 1100 includes an illumination unit 1110, an imaging optical system 1120, an imaging unit 1130, and a stage measurement unit 1140. In the microscope unit 1100, the illumination unit 1110 illuminates the prepared slide 100 held on the slide stage 1500, and the imaging optical system 1120 forms an image of the prepared slide enlarged by a predetermined magnification. A light receiving surface of the imaging unit 1130 then receives a light flux from the imaging optical system 1120, and the prepared slide 100 is thus imaged.

The illumination unit 1110 includes a light source (e.g., a white light source or a light source which can switch light corresponding to red (R), green (G), and blue (B) wavelengths) and an illumination optical system that guides the light flux from the light source to the prepared slide 100. The stage measurement unit 1140 measures the position of the slide stage 1500 in X, Y, and Z directions according to those three coordinates, and obtains the position and orientation information of the slide stage 1500. More specifically, the stage measurement unit 1140 can acquire orientation information of the slide stage 1500 by measuring the heights (i.e., positions in the Z-direction) of at least three points on an upper surface of the slide stage 1500. A laser displacement meter and a capacitance type displacement meter may be used as the stage measurement unit 1140.

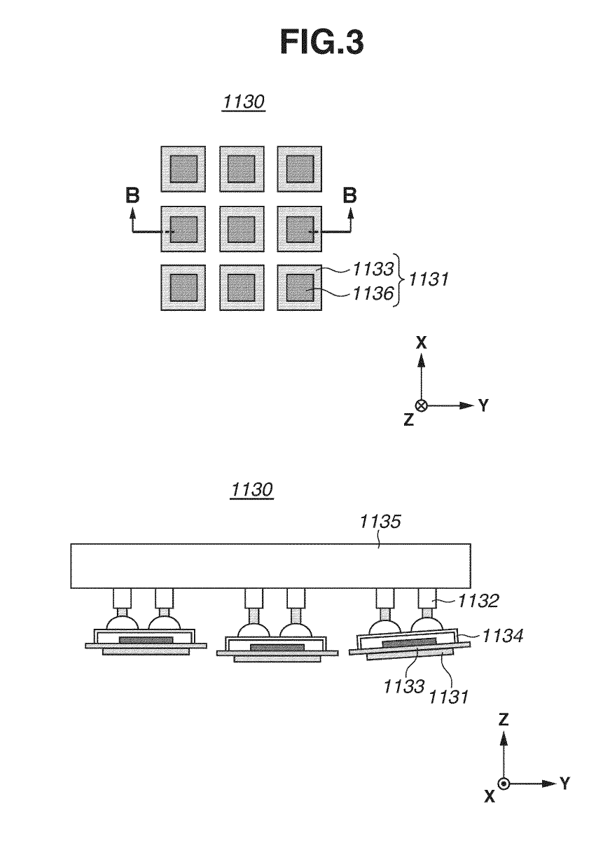

FIG. 3 is a schematic diagram illustrating the main portion of the imaging unit 1130 included in the microscope unit 1100. The upper surface of the imaging unit 1130 is illustrated in an upper portion of FIG. 3, and a cross-sectional view illustrating the imaging unit 1130 along a line B-B illustrated in the upper portion of FIG. 3 is illustrated in a lower portion of FIG. 3. According to the present exemplary embodiment, the imaging unit 1130 includes a plurality of image sensors 1131 each of which is arranged in the X and Y directions. Each image sensor 1131 includes a circuit board 1133 and a light receiving surface 1136 that receives the light from the prepared slide 100 and performs imaging. The image sensors 1131 are arranged at predetermined intervals from each other. The number and the arrangement of the image sensors 1131 are determined as appropriate according to a size of a field of view of the imaging optical system 1120, an area of the image sensor 1131, size and shape of the prepared slide 100, and a space necessary for disposing a driving unit 1132 to be described below. A complementary metal-oxide semiconductor (CMOS) image area sensor or a charge-coupled device (CCD) image area sensor can be used as the image sensor 1131. In addition, a device for cooling each of the plurality of image sensors 1131 to a predetermined temperature may be disposed.

Further, according to the present exemplary embodiment, the imaging unit 1130 includes a plurality of the driving units 1132 capable of changing the position and the orientation of the respective image sensors 1131. Each of the driving units 1132 is disposed on a surface plate 1135, and connected to the image sensor 1131 via a holding member 1134 and the circuit board 1133. For example, if three cylinders are disposed on each image sensor 1131 as the driving unit 1132, expansion and contraction of each of the cylinders cause z-translation (i.e., driving in the Z-direction) and an XY tilt (i.e., driving around the X-axis and the Y-axis) of the image sensor 1131. By disposing such driving unit 1132, each image sensor 1131 can be driven to perform focus adjustment with respect to the prepared slide 100. Since a driving range of the image sensor 1131 is limited, there may be a portion of which focus cannot be adjusted by the image sensor 1131 depending on the surface shape of the prepared slide 100. In such a case, the slide stage 1500 is also driven along with driving of the image sensor 1131, so that the focus adjustment can be performed on the entire observation area of the prepared slide 100.

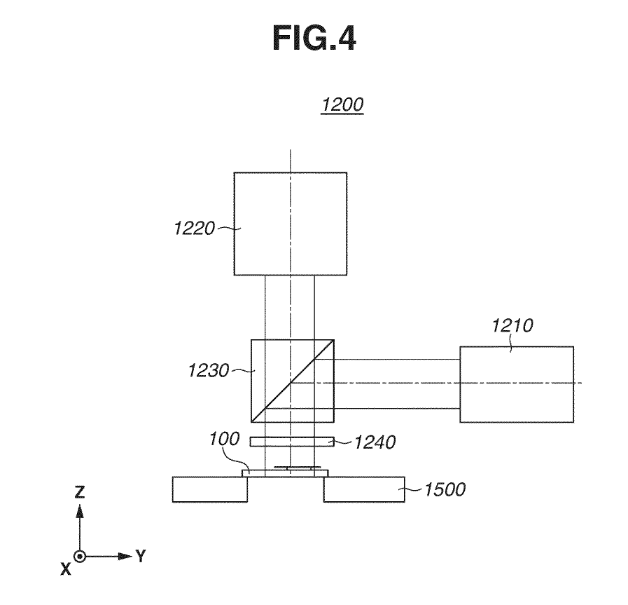

FIG. 4 illustrates the surface shape acquisition unit 1200 according to the present exemplary embodiment. Referring to FIG. 4, the surface shape acquisition unit 1200 includes a measurement illumination unit 1210, a surface shape measurement unit 1220, a polarization beam splitter 1230, and a λ/4 plate 1240. The surface shape acquisition unit 1200 can obtain information about undulation (i.e., height distribution) generated on the surface of the prepared slide 100.

The measurement illumination unit 1210 which illuminates the prepared slide 100 uses a semiconductor laser or a white light emitting diode (LED) light source as the light source, and emits a parallel beam. The light from the measurement illumination unit 1210 is reflected on the surface of the prepared slide 100 via the polarization beam splitter 1230 and the λ/4 plate 1240. The reflected light is then guided to the surface shape measurement unit 1220. The surface shape measurement unit 1220 includes a wavefront sensor, and measures a wave front height distribution of the light reflected on the surface of the prepared slide 100. The information about the surface shape of the prepared slide 100 is thus obtained from optical path lengths of the measured incident light and reflected light.

A sensor which measures the wave front, such as a Shack-Hartmann sensor and an interferometer, may be used as the surface shape measurement unit 1220. In addition, a position measurement device such as the laser displacement meter or a contact type position sensor may be configured as the surface shape measurement unit 1220 to measure the surface height at a plurality of points on the prepared slide 100. The surface shape acquisition unit 1200 may be a reading apparatus such as a two-dimensional code reader which reads surface shape information previously recorded in the label 140 of the prepared slide 100. Further, the surface shape acquisition unit 1200 may be an apparatus which obtains, by communication on a local area network (LAN), the surface shape information previously measured by another unit.

The slide stage 1500 for holding the prepared slide 100 is capable of performing XYZ translation and the XY tilt. The slide stage 1500 can move the prepared slide 100 between an imaging position of the microscope unit 1100 and a measurement position of the surface shape acquisition unit 1200 as illustrated in FIG. 1. In addition, the position and the orientation of the slide stage 1500 can be controlled to be desired values based on position and orientation information obtained by the stage measurement unit 1140. A translation mechanism using a ball screw or an elevation mechanism using three or more piezoelectric elements may be employed as a driving mechanism of the slide stage 1500. An opening is disposed in the slide stage 1500 for passing light from the illumination unit 1110 in the microscope unit 1100.

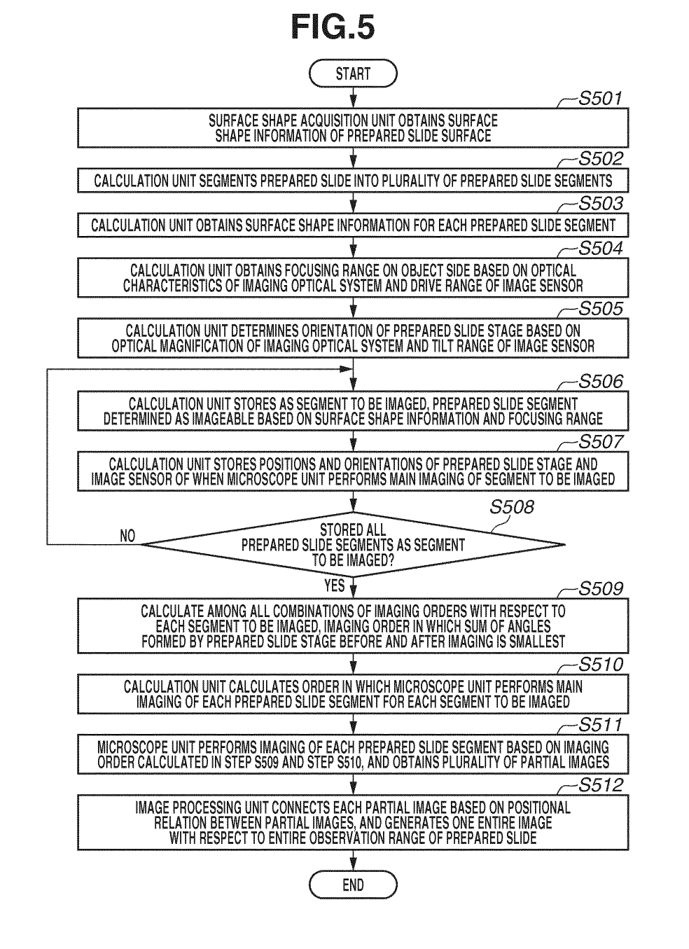

A detailed procedure for obtaining an image of the observation area of the prepared slide 100 performed by the image acquisition apparatus 1000 according to the present exemplary embodiment will be described below with reference to a flowchart illustrated in FIG. 5. The processing in step S501 to step S510 in the flowchart is performed for calculating the order of imaging the prepared slide 100, and the processing in step S511 and step S512 is performed for actually imaging (i.e., performing main imaging) the prepared slide 100 and obtaining the image thereof.

In step S501, the surface shape acquisition unit 1200 obtains the surface shape information of the prepared slide 100.

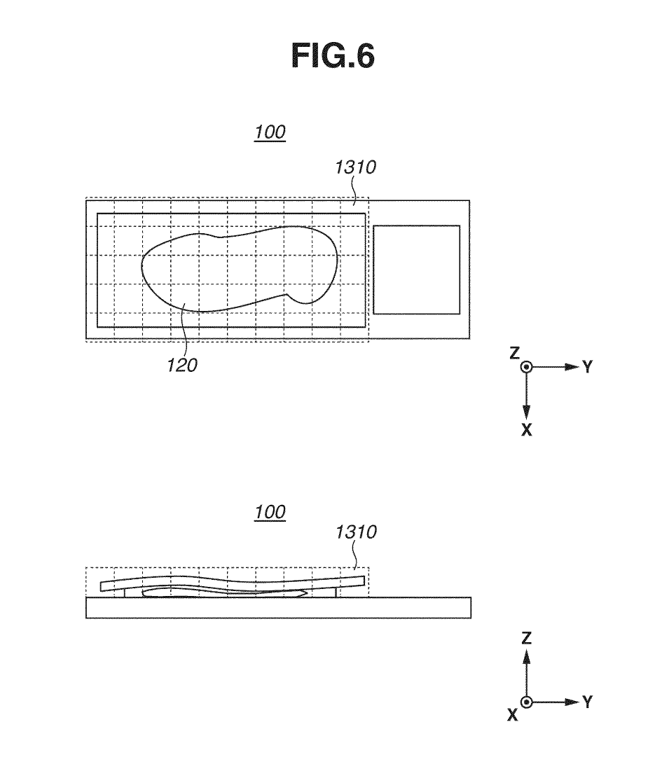

In step S502, the calculation unit 1300 segments the prepared slide 100 into a plurality of prepared slide segments 1310 as illustrated in FIG. 6. FIG. 6 illustrates a state in which the prepared slide 100 is segmented into the plurality of prepared slide segments 1310. Referring to FIG. 6, each of the prepared slide segments 1310 corresponds to a range that one image sensor 1131 in the imaging unit 1130 can capture an image (i.e., an imaging range). Accordingly, all of the prepared slide segments 1310 can be imaged by changing relative positions of the slide stage 1500 and the imaging unit 1130 when performing main imaging. Intervals and overlapping areas (to be described in detail below) between adjacent prepared slide segments 1310 are omitted in FIG. 6. A personal computer (PC), a microcomputer board, and a calculation program can be used as the calculation unit 1300.

For example, it is assumed that each of the 3 by 3 image sensors 1131 illustrated in FIG. 3 includes the light receiving surface 1136 of 20 mm square, and each light receiving surface 1136 is arranged in a lattice shape at a pitch of 38 mm. In such a case, if the optical magnification of the imaging optical system 1120 is 10 times, the imaging range that can be imaged by each of the image sensor 1131 becomes a 2 mm square, and 3 by 3 imaging ranges become arranged at a pitch of 3.8 mm on the object side. The calculation unit 1300 thus stores the 3 by 3 imaging ranges. It is then assumed that the position of the slide stage 1500 in the X direction is moved by 1.9 mm (i.e. a half of 3.8 mm which is the arrangement pitch of the imaging range) after the calculation unit 1300 stores the imaging range. Accordingly, after moving the slide stage 1500, each imaging range is arranged at a pitch of 3.8 mm by having an overlapping region of 0.1 mm in the X direction with each imaging range stored in the calculation unit 1300. As described above, the imaging range stored at each position is set as the prepared slide segment 1310 by assuming the case where the slide stage 1500 is moved to fill the interval between each of the receiving surfaces 1136. Thus, the entire observation area of the prepared slide 100 can be segmented.

In step S502, the calculation unit 1300 stores the positions in the X and Y directions of the image sensor 1131 corresponding to each prepared slide segment 1310 and the slide stage 1500. According to the present exemplary embodiment, the entire surface of the prepared slide 100 is segmented into the prepared slide segments 1310 as illustrated in FIG. 6. However, the surface shape acquisition unit 1200 may previously detect the range in which the specimen 120 exists (i.e., the observation area), and only segment the detected range. Further, after the calculation unit 1300 segments the entire surface of the prepared slide, the calculation unit 1300 may set as the prepared slide segment 1310, only the portion including the observation area. If the specimen 120 (i.e., the observation area) is smaller than the imaging range that can be imaged by one image sensor 1131, the one imaging range including the observation area is set as the prepared slide segment 1310.

In step S503, the calculation unit 1300 obtains the surface shape of each prepared slide segment 1310 which is obtained by the segmenting processing in step S502 from the surface shape information of the entire observation area of the prepared slide 100 obtained in step S501.

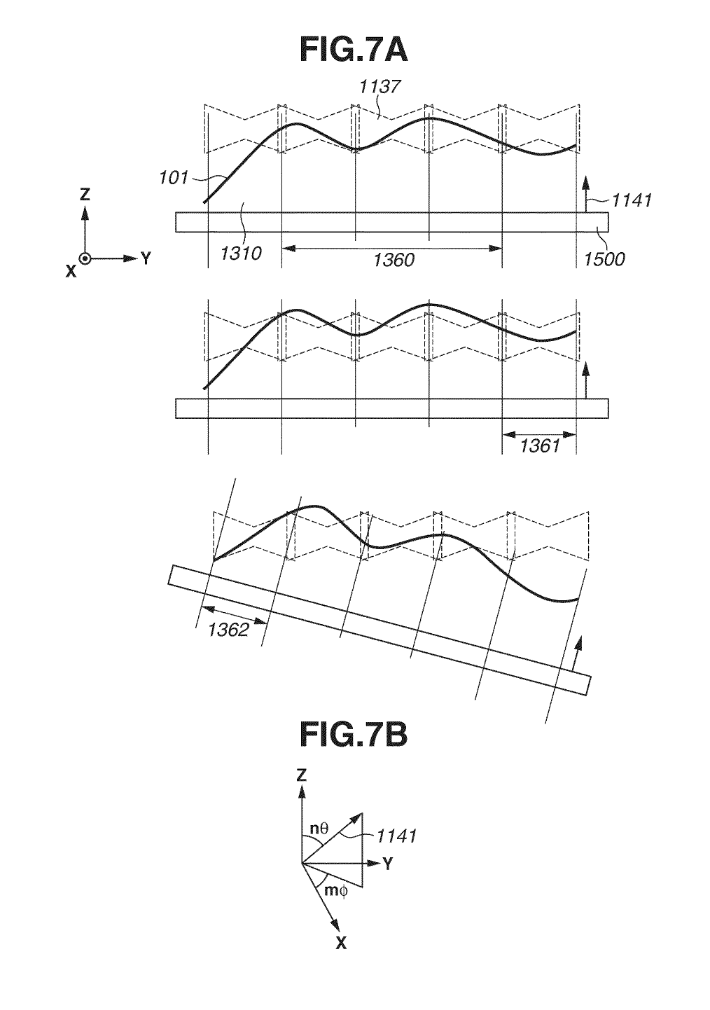

In step S504, the calculation unit 1300 obtains a focusing range 1137 on the object side, based on the optical characteristics of the imaging optical system 1120 and a drive range (i.e., a translation range and a tilt range) of the image sensor 1131 (i.e., the light receiving surface 1136). FIG. 7A illustrates a relation among the slide stage 1500, a surface (prepared slide surface) 101 of the prepared slide 100, and the focusing range 1137. The focusing range 1137 is a range obtained according to the optical characteristics of the imaging optical system 1120 and the drive range of each image sensor 1131 (i.e., the light receiving surface 1136). If an area of the prepared slide surface 101 which is included in the focusing range 1137 is imaged, a focused image can be obtained.

The optical characteristics of the imaging optical system 1120 include the optical magnification of the imaging optical system 1120, a depth of focus, a depth of field, and the like. The information about the optical characteristics is previously stored in the calculation unit 1300, so that the information can be appropriately referred to when the focusing range 1137 is obtained. If the microscope unit 1100 is configured to be capable of adjusting a numerical aperture (NA) by disposing an aperture in the imaging optical system 1120, the optical characteristics also change according to a change in the NA. In such a case, the calculation unit 1300 may previously store a database of the optical characteristics corresponding to each NA, or the calculation unit 1300 may calculate the optical characteristics according to the change in the NA. In addition, the optical characteristics information may be stored in another recording unit in the image acquisition apparatus 1000, or an external device of the image acquisition apparatus 1000, and the calculation unit 1300 may refer to the information as appropriate.

If it is assumed that the optical magnification of the imaging optical system 1120 is 10 times, the area on the object side corresponding to 1/100 of the Z translation range and 1/10 of the tilt range of the light receiving surface 1136 in each image sensor 1131 becomes the focusing range 1137. According to the present exemplary embodiment, the light receiving surfaces 1136 are arranged at predetermined intervals from each other as illustrated in FIG. 3. However, the focusing range 1137 may be obtained so that there is no interval in an X-Y plane by considering that the slide stage 1500 is movable.

The orientation of the slide stage 1500 is expressed as a vector 1141 defined as follows. In the definition, “n” and “m” are integers (0, ±1, ±2, ±3, . . . ). (sin(nθ)·cos(mφ), sin(nθ)·sin(mφ), cos(nθ))

The vector 1141 indicates that the orientation of the slide stage 1500 is determined as a discrete value according to the present exemplary embodiment. FIG. 7B illustrates an example of the vector 1141.

In step S505, the calculation unit 1300 determines, based on the optical magnification of the imaging optical system 1120 and the tilt range of the image sensor 1131, the orientation that the slide stage 1500 can take, i.e., the values of θ and φ of the vector 1141. For example, it is assumed that the optical magnification of the imaging optical system 1120 is 10 times, and the tilt range of each image sensor 1131 is 10 milliard (mrad). In such a case, if an average tilt (i.e., a tilt of an approximate plane of the surface) of the prepared slide surface 101 is less than or equal to 1 mrad, the focus can be adjusted based only on the tilt of the image sensor 1131. Accordingly, the values of θ and φ of the vector 1141 are determined to be within a range between −1 mrad and 1 mrad.

In step S506, the calculation unit 1300 determines, based on the surface shape of the prepared slide surface 101 and the focusing range 1137, whether each prepared slide segment 1310 can be imaged. More specifically, as illustrated in a top portion of FIG. 7A, it is assumed that the values of “n” and “m” of the vector 1141 are 0, i.e., the upper surface of the slide stage 1500 is perpendicular to an optical axis direction (Z direction) of the imaging optical system 1120. In this case, based on the surface shape of the prepared slide surface 101 for each prepared slide segment 1310 obtained in step S503 and the focusing range 1137 obtained in step S504, the calculation unit 1300 determines that the prepared slide segment 1310 which includes the area of the prepared slide surface 101 that is within the focusing range 1137 can be imaged. The calculation unit 1300 then stores as a segment to be imaged 1360, the prepared slide segment 1310 which is determined as imageable.

According to the present exemplary embodiment, the position of the slide stage 1500 in the Z direction when determining the segment to be imaged 1360 is determined as appropriate according to the surface shape of the prepared slide surface 101 and the focusing range 1137. For example, according to the present exemplary embodiment, the position of the slide stage 1500 in the Z direction is set so that the number of prepared slide segments 1310 which includes the area of the prepared slide surface 101 that is within the focusing range 1137 is maximized. Accordingly, a change amount in the position of the slide stage 1500 when performing main imaging can be reduced. If the prepared slide surface 101 is approximately flat and the entire prepared slide surface 101 is within the focusing range 1137, all of the prepared slide segments 1310 can be classified as one segment to be imaged.

In step S507, the calculation unit 1300 calculates the position and the orientation of the slide stage 1500 when the microscope unit 1100 performs main imaging of the segment to be imaged 1360 classified in step S506. Further, the calculation unit 1300 stores the position and the orientation of the image sensor 1131 when the focus is adjusted on the prepared slide surface 101, for each prepared slide segment 1310 included in the segment to be imaged 1360. The information about the positions and orientations of the slide stage 1500 and each image sensor 1131 are used when the microscope unit 1100 performs main imaging of each of the prepared slide segments 1310 classified as the segment to be imaged 1360.

The position of the image sensor 1131 in the Z direction when the focus is adjusted on the prepared slide surface 101 can be calculated using the surface shape information of each prepared slide segment 1310 obtained in step S503. In other words, the position of each image sensor 1131 is calculated based on the height of the prepared slide surface 101 at the center of the X-Y direction of the prepared slide segment 1310 corresponding to each image sensor 1131. Further, the orientation of the image sensor 1131 when the focus is adjusted on the prepared slide surface 101 can be calculated, for example, based on the average tilt of the prepared slide surface 101 within the prepared slide segment 1310 corresponding to each image sensor 1131.

In step S508, the calculation unit 1300 determines whether all the prepared slide segments 1310 in the observation area of the prepared slide 100 are stored as the segment to be imaged 1360. For example, as illustrated in the top portion of FIG. 7A, if a portion of the prepared slide surface 101 is not within the focusing range 1137, and it is not determined that the prepared slide segment 1310 including such a portion can be imaged (NO in step S508), the process returns to step S506.

According to the present exemplary embodiment, it is assume that, after returning to step S506, the slide stage 1500 is moved in the Z direction without changing the vector 1141 as illustrated in the middle portion of FIG. 7A. In other words, the calculation unit 1300 stores as a segment to be imaged 1361, the prepared slide segment 1310 which includes the portion of the prepared slide surface 101 that newly enters within the focusing range 1137 by moving the slide stage 1500. In such a case, it is desirable to move the slide stage 1500 so as to maximize the number of prepared slide segments 1310 which is newly determined as imageable among the prepared slide segments 1310 not stored as the segments to be imaged 1360 illustrated in the top portion of FIG. 7A. Accordingly, the change amount in the position of the slide stage 1500 when performing main imaging can be reduced.

As described above, the prepared slide segment 1310 which is not determined as imageable in the top portion of FIG. 7A can be newly stored as the segment to be imaged 1361. The process then proceeds to step S507, and the calculation unit 1300 stores the position and the orientation of the slide stage 1500 with respect to the segment to be imaged 1361, and the positions and the orientations of the slide stage 1500 and the image sensor 1131 when performing main imaging for each prepared slide segment 1310.

If there is still a prepared slide segment 1310 which is not determined as imageable even when the slide stage 1500 is moved in the Z direction (NO in step S508), the process returns to step S506 again. According to the present exemplary embodiment, a case where the orientation of the slide stage 1500 is changed by changing “n” and “m” of the vector 1141 as illustrated in a bottom portion of FIG. 7A will be described below. More specifically, the prepared slide segment 1310 which includes portion of the prepared slide surface 101 that newly enters within the focusing range 1137 by changing the position and the orientation of the slide stage 1500 is stored as a segment to be imaged 1362. The process in step S507 is then performed again with respect to the segment to be imaged 1362.

As described above, the processes in step S506 and step S507 are repeated until the calculation unit 1300 stores all of the prepared slide segments 1310 as the segment to be imaged. Further, the calculation unit 1300 stores the position and orientation information of the slide stage 1500 and the prepared slide segments 1310 with respect to each of the stored segment to be imaged. According to the present exemplary embodiment, the initial values of “n” and “m” of the vector 1141 are set as zero. However, the process may be started by setting other values as the initial values. For example, the position and the orientation of the slide stage 1500 when the number of prepared slide segments 1310 that can be imaged becomes maximum are calculated, and the values of “n” and “m” in such a case are set as the initial values. The main imaging can thus be more efficiently performed. In addition, a representative tilt (e.g., an average tilt or a tilt by performing three-point measurement) for each prepared slide segment 1310 may be obtained based on the surface shape obtained in step S503. The available range of “n” and “m” are then calculated from the range of each representative tilt, and the process in step S506 may be performed.

In step S509, the calculation unit 1300 calculates the imaging order of the segments to be imaged 1360, 1361, and 1362 stored in step S506 by the microscope unit 1100 in the main imaging. In this step, the calculation unit 1300 calculates the imaging order of the segments to be imaged 1360, 1361, and 1362 so as to minimize the sum of the angles formed by the orientations of the slide stage 1500 corresponding to each of the segments to be imaged which are to be imaged in a consecutive order. The angles formed between each of the orientations are positive values, regardless of the direction of a change with respect to the orientation.

More specifically, the calculation unit 1300 obtains combinations of the imaging order of each segment to be imaged, and with respect to all combinations, compares the information pieces about the orientation of the slide stage 1500 corresponding to the segments to be imaged which are to be imaged in the consecutive order. The calculation unit 1300 thus calculates the angle formed by the vectors 1141 of the slide stage 1500 corresponding to each of the segments to be imaged stored in step S507. The calculation unit 1300 then selects the imaging order in which the sum of all angles calculated with respect to the combinations of the segment to be imaged is smallest. Accordingly, the calculation unit 1300 can calculate an order of changing the orientation so that a change amount of the orientation of the slide stage 1500 is smallest before and after changing the segment to be imaged by the microscope unit 1100 in performing main imaging.

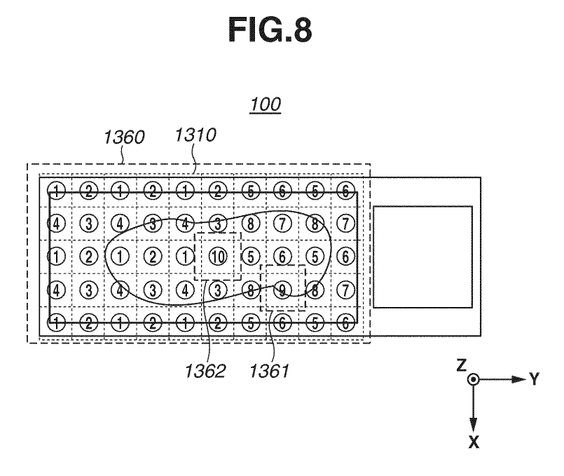

In step S510, the calculation unit 1300 calculates the imaging order by the microscope unit 1100 in the main imaging with respect to each of the prepared slide segment 1310 included in each segment to be imaged. For example, a case where the segments to be imaged 1360, 1361, and 1362 are classified in step S506 as illustrated in FIG. 8, and the microscope unit 1100 is to sequentially perform imaging of each segment will be described below. According to the present exemplary embodiment, the imaging unit 1130 including image sensors 1131 which are discretely arranged three by three is used in imaging. In such a case, each prepared slide segment 1310 is imaged in the order of a number assigned thereto as illustrated in FIG. 8. In other words, all prepared slide segments 1310 included in the segment to be imaged 1360 are sequentially imaged. Then, all prepared slide segments 1310 included in the segment to be imaged 1361 are sequentially imaged. Lastly, all prepared slide segments 1310 included in the segment to be imaged 1362 are sequentially imaged. As described above, the calculation unit 1300 calculates the imaging order of the segment to be imaged 1360 so that all prepared slide segments determined as imageable in the same orientation of the slide stage 1500 are sequentially imaged in the respective positions of the slide stage.

In step S511, the microscope unit 1100 performs main imaging of the prepared slide 100 based on the position and orientation information and the imaging order which are stored and calculated by the calculation unit 1300 in each of the above-described steps. More specifically, first, the control unit 1600 controls the positions and the orientations of the slide stage 1500 and the image sensor 1131, and issues an imaging instruction to the microscope unit 1100. Since the plurality of image sensors 1131 is discretely arranged at predetermined intervals in the imaging unit 1130 according to the present exemplary embodiment, an image of each prepared slide segment 1310 (i.e., a partial image) is discretely obtained in one imaging. Therefore, the slide stage 1500 is moved, and imaging is performed a plurality of times by changing the relative positions of the prepared slide 100 and the image sensor 1131, so that the partial images are obtained to fill in the gaps between each of the image sensors 1311. Accordingly, each of the prepared slide segments 1310 which are obtained by segmenting the entire observation area of the prepared slide 100 can be imaged in the order which can minimize the change amount of the orientation of the slide stage 1500.

In step S512, the image processing unit 1400 connects the plurality of partial images imaged by each image sensor 1131 based on the positional relations among the plurality of partial images, and generates one entire image corresponding to the entire observation area of the prepared slide 100. At that time, a positional variation of the partial image for each segment to be imaged is calculated based on the position and orientation information of the slide stage 1500 measured by the stage measurement unit 1140 in order to reduce the image deterioration due to the misalignment between the adjacent partial images. The image processing unit 1400 thus performs image processing based on the positional variation, so that the misalignment of the partial images in the entire image can be corrected. Examples of the image processing unit 1400 include the combination of the PC and an image processing program, and an image processing circuit board.

As described above, according to the present exemplary embodiment, the calculation unit 1300 is capable of calculating the imaging order of the prepared slide in which the amount and the number of times of changing the orientation of the slide stage 1500 are minimized. More specifically, the calculation unit 1300 stores, for each orientation of the slide stage 1500, the prepared slide segments 1310 determined as imageable as the segment to be imaged. The calculation unit 1300 then calculates the imaging order to perform imaging by each segment to be imaged. Accordingly, all prepared slide segments 1310 which are imageable in the same orientation of the slide stage 1500 can be imaged by only changing the position of the slide stage 1500. The number of changing the orientation of the slide stage 1500 can thus be reduced. Further, the change amount of the orientation of the slide stage 1500 can be reduced by calculating the imaging order of the prepared slides so as to minimize the change amount of the orientation of the slide stage 1500 in main imaging.

As described above, the image acquisition apparatus 1000 according to the present exemplary embodiment can reduce the time required for controlling the slide stage 1500 and calculating the change amount of the position of each partial image. The image acquisition apparatus 1000 can thus reduce the time necessary for obtaining the entire image of the observation area of the prepared slide 100.

According to the present exemplary embodiment, the imaging unit 1130 includes the plurality of image sensors 1131. However, the present invention is not limited to the above configuration, and the imaging unit 1130 may be configured by one image sensor 1131. Further, according to the present exemplary embodiment, the position and the orientation of each image sensor 1131 in the imaging unit 1130 are changeable. However, the imaging unit 1130 may be configured so that the image sensor 1131 can only perform Z translation, or so that the image sensor 1131 cannot be driven by not including the driving unit 1132. Furthermore, the relative positions of the prepared slide 100 and the image sensor 1131 can be configured to be changeable by causing the entire imaging unit 1130 to be drivable in the X, Y, and Z directions, and moving at least one of the slide stage 1500 and the imaging unit 1130 in the X and Y directions.

In a case of the configuration in which the image sensor 1131 is not driven, the calculation unit 1300 obtains the focusing range based on the optical characteristics of the imaging optical system 1120 in step S504 illustrated in FIG. 5. In other words, the image acquisition method according to the present exemplary embodiment is applicable by only driving the slide stage 1500 without driving the image sensor 1131.

Further, according to the present exemplary embodiment, it is assumed that the imaging optical system 1120 is an enlarging system, and the position and the orientation of the slide stage 1500 are accurately measured and controlled. However, the present invention is not limited to the above configuration. For example, in a case where the imaging optical system 1120 is a reduction projection system, the accuracy of controlling the image sensor 1131 greatly affects an obtained image as compared to controlling the slide stage 1500. In such a case, the above-described image acquisition process is performed by reducing the amount and the number of times of changing the position and the orientation of the image sensor 1131.

Furthermore, according to the present exemplary embodiment, the calculation unit 1300 is independently arranged from each unit. However, the calculation unit 1300 may be integrated with the microscope unit 1100, the surface shape acquisition unit 1200, the image processing unit 1400, or the control unit 1600. Moreover, according to the present exemplary embodiment, the image acquisition apparatus 1000 includes one microscope unit 1100, one surface shape acquisition unit 1200, one calculation unit 1300, and one image processing unit 1400. However, the present invention is not limited thereto, and the image acquisition apparatus 1000 may include a plurality of each of the units.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims the benefit of Japanese Patent Application No. 2012-150470 filed Jul. 4, 2012, which is hereby incorporated by reference herein in its entirety.

What is claimed is:

1. An image acquisition apparatus comprising:
a slide stage configured to hold a prepared slide;
an imaging optical system configured to form an image of the prepared slide;
an imaging unit including an image sensor configured to perform imaging of the prepared slide;
a stage measurement unit configured to obtain orientation information of the slide stage; and
a calculation unit configured to calculate an order of imaging the prepared slide,
wherein an orientation of the slide stage is changeable based on the orientation information, and
wherein the calculation unit obtains, based on a surface shape of the prepared slide and optical characteristics of the imaging optical system, a relation between an orientation of the slide stage and an area of the prepared slide which can be imaged with respect to the orientation, and calculates an order of imaging the prepared slide in each orientation of the slide stage based on the obtained relation.

2. The image acquisition apparatus according to claim 1,
wherein the calculation unit obtains, based on the surface shape of the prepared slide and the optical characteristics of the imaging optical system, respective orientations of the slide stage which are changed when the slide is imaged,
wherein the calculation unit calculates an order of changing an orientation of the slide stage when a sum of angles formed by the slide stage before and after changing an orientation is smallest, and
wherein the calculation unit calculates an order of imaging the prepared slide based on the calculated changing order.

3. The image acquisition apparatus according to claim 2, wherein the calculation unit obtains, based on the surface shape of the prepared slide and the optical characteristics of the imaging optical system, respective orientations of when a number of times of changing an orientation of the slide stage which is changed in imaging the prepared slide is smallest.

4. The image acquisition apparatus according to claim 1, wherein a position of the slide stage is changeable, and
wherein the calculation unit obtains, based on a surface shape of the prepared slide and the optical characteristics of the imaging optical system, a position of the slide stage when an imageable area among areas of the prepared slide which are not yet imaged becomes largest for each orientation of the slide stage, and calculates an order of imaging the prepared slide so as to perform imaging by driving the slide stage to the obtained position.

5. The image acquisition apparatus according to claim 1, wherein the calculation unit calculates an order of imaging the slide stage so as to perform imaging of all imageable areas of the prepared slide for each orientation of the slide stage.

6. The image acquisition apparatus according to claim 1, further comprising a surface shape acquisition unit configured to obtain a surface shape of the prepared slide,
wherein the calculation unit calculates an order of imaging the prepared slide based on the surface shape of the prepared slide obtained by the surface shape acquisition unit and the optical characteristics of the imaging optical system.

7. The image acquisition apparatus according to claim 1, wherein at least one of a position and an orientation of the image sensor can be driven, and
wherein the calculation unit calculates an order of imaging the prepared slide based on the surface shape of the prepared slide, the optical characteristics of the imaging optical system, and a driving range of the image sensor.

8. The image acquisition apparatus according to claim 1, wherein the imaging unit includes a plurality of the image sensors.

9. A method for obtaining an image performed by an image acquisition apparatus in which an imaging optical system forms an image of a prepared slide held by a slide stage and an imaging unit images the prepared slide, the method comprising:
obtaining, based on a surface shape of the prepared slide and optical characteristics of the imaging optical system, a relation between an orientation of the slide stage and an area of the prepared slide which can be imaged with respect to the orientation;
calculating an order of imaging the prepared slide in each orientation of the slide stage based on the obtained relation; and
imaging the prepared slide based on the calculated order.
